(19) United States
(12) Patent Application Publication
(10) Pub. No.: US 2014/0265083 A1
(43) Pub. Date: Sep. 18, 2014

(54) APPARATUS FOR ASSISTING IN HANDLING SMALL ITEMS

(71) Applicant: Lanae Bach, Morgan Hill, CA (US)

(72) Inventor: Lanae Bach, Morgan Hill, CA (US)

(21) Appl. No.: 13/802,744

(22) Filed: Mar. 14, 2013

(51) Int. Cl. B25B 11/00

(52) U.S. Cl. CPC B25B 11/00
USPC 269/3; 29/592

(57) ABSTRACT

An apparatus for assisting in beading is provided. The apparatus has an enlarged flat top, akin to a micro-table and may be used as a ring or a wristband. A tacky tape is provided on the flat top. The beads to be thread are placed on top of the tape, so that they remain in place. The person then uses the needle to thread the beads.

### BACKGROUND

1. Field of the Invention

The subject invention relates to device for assisting persons engaged in arts and crafts and, more specifically, for assisting handling small items, such as beads.

2. Related Art

Engaging in arts and crafts may require handling of small items. Long period of handling small items over a conventional desk may lead to back pain, as the artist hunches over the table for prolonged periods. Additionally, handling small items may be difficult for the elderly or for those with poor eyesight. Consequently, such persons are prevented from engaging in such arts and crafts, or prevented from doing it for a prolonged period.

Recently beading has become a very popular hobby. There are various methods for beading, but most require the threading of a string through the beads. When using small beads, the hole is very small and a needle is used to thread the string through the beads. However, when the beads are very small, this operation becomes difficult, as one has to handle each bead separately and thread it using the needle. Since the beads are very small, they are very difficult to handle. Also, one needs to hunch over the worktable during this task, which may create back pain or other problems.

What's needed in the art is an apparatus and method to enable easier threading of strings through beads.

### SUMMARY

The following summary of the invention is provided in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Various embodiments of the subject invention provide an apparatus that assist in handling small items, such as small beads. Specific embodiments of the invention enable easy threading of strings through beads, especially small beads.

According to embodiments of the invention, a ring or a wristband is provided, which the person doing the beading wears on the hand that does not hold the needle (for right persons the ring/wristband would be on the left hand, while for lefties it would by on the right hand). The ring/wristband has a top work surface, akin to a micro-table. A tacky surface, such as, e.g., tacky film, gel or tape is provided on the top surface. The items to be handled, such as beads to be thread, are placed on top of the tape, so that they remain in place. The person then uses the needle to thread the beads.

Various disclosed embodiments provide an apparatus suitable for beading, comprising: a ring part suitable for wearing on a user's finger or arm; a top work-surface part affixed to the ring part; and, a tacky film provided over the top work-surface. The ring part may be made of plastic material, elastic band, Velcro, etc. The tacky part may be a tacky layer, such as spray-on, spread, etc., a double-sided tape, a plurality of tapes staked one on top of the other, etc. For example, Scotch® 667 Removable Double-Sided Tape, marketed by 3M® can be used.

A neck and a frame attached to the neck may be included, wherein the frame may support a magnifying glass, an illumination source, or both. A top cover can be removably mountable to the top work-surface and may or may not include a storage enclosure or cavity.

A method of manufacturing an apparatus for beading is disclosed, comprising: fabricating a ring part; fabricating a work-surface affixed to the ring part; and providing a tacky layer over the work-surface. The tacky layer may be made by spreading or spraying tacky layer, or by using double-sided adhesive tape.

### BRIEF DESCRIPTION OF THE DRAWINGS

Other aspects and features of the invention would be apparent from the detailed description, which is made with reference to the following drawings. It should be appreciated that the detailed description and the drawings provides various non-limiting examples of various embodiments of the invention, which is defined by the appended claims.

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic illustration of a person's hand wearing an apparatus according to embodiments of the invention.

FIG. 2 is a schematic of an apparatus according to an embodiment of the invention.

FIG. 3 is an illustration showing the bottom part of the apparatus according to an embodiment of the invention.

FIG. 4 illustrates another embodiment of the invention, which may be structured in the form of a ring or a wristband.

FIGS. 5A and 5B illustrate another embodiment according to the invention.

FIG. 6 illustrates another embodiment of the invention.

FIG. 7 illustrates another embodiment of the invention having a curved top.

FIG. 8 illustrates another embodiment of the invention.

FIG. 9 illustrate an embodiment of the invention, which may be implemented as a ring or a wristband.

FIG. 10 illustrates an embodiment wherein the work surface may be rotated.

FIG. 11 illustrates an embodiment wherein the cover can be used as a work surface when in the open position.

FIG. 12 illustrates an embodiment wherein the working surface is provided with undulations or corrugation so as to increase the working surface.

### DETAILED DESCRIPTION

Embodiments of the subject invention provide apparatus enabling easy handling of small items. While the apparatus may be used for handling various small items, embodiments of the invention will be described with respect to apparatus for holding beads for easier threading of the beads. However, it should be understood that the description of these embodiments is for non-limiting illustration purposes only, and that the inventive apparatus may be used for handling other small items.

FIG. 1 illustrates a hand of a person wearing an apparatus 100 according to an embodiment of the invention. In the embodiment of FIG. 1 the apparatus 100 is in the form of a ring, but as will be demonstrated in other embodiments, the apparatus may also be in the form of a wristband, etc. The apparatus 100 generally comprises a top work-surface 110 affixed to a ring portion 120. The top work-surface 110 may be made of a rigid material, such as plastic, while the ring portion 120 may be made of a rigid material, such as plastic, or a soft material, such as elastic band or Velcro®. The top work-surface 110 has a relatively flat or somewhat curved surface 114, which is provided with a tacky material 130. The tacky material 130 may be, e.g., a tacky layer prayed or spread on the top surface, a two-sided tape adhered to the top surface, etc. During use, plurality of beads 140 are placed on the tacky surface 130, to enable easy threading of the beads.

FIG. 1 further illustrates an apparatus 100A according to another embodiment of the invention wherein the apparatus 100A is structure to fit a user's wrist. The apparatus 100A is constructed of parts similar to apparatus 100, and comprises a wristband part 120A, and a top work-surface part 110A affixed to the wristband 120A. A tacky layer 130A is provided over the flat or curved surface 114A of the top work-surface part 110A. The tacky layer 130A may be tacky material applied directly onto the flat top part 110A. Alternatively, the tacky layer may be provided on a two-sided tape, which is applied to the top part 110A. Another option is to have a stack of tapes, each tape having a tacky film applied to an upper face thereof. When the embodiment having the stack of tacky tapes is used, when the upper most tape loses its tackiness, it may be removed and the one below it can be used as a fresh tacky tape.

FIG. 2 illustrates an apparatus 200 according to an embodiment of the invention. In the embodiment of FIG. 2, a top work-surface 210 is affixed to a ring part 220. The top work-surface 210 is made of a rigid material, which in this example is plastic, and has a top surface 214. The ring part 220 may be made of a rigid material, such as plastic, but in this embodiment it is made of a two part Velcro® material, so that it can be fit to any size finger. A plurality of tacky tapes 230 is provided on the flat top surface 214. The plurality of tacky tapes are arrange on top of each other, in a manner similar to Post-it® notes, so that when the tackiness is lost in one tape, it may be removed and the one below it may be used.

Also shown in FIG. 2 is a cover 250, which may be used to cover the top part 210, to prevent dust or other matter from sticking to the tacky tape 230. The cover may be used when the apparatus is stored and can keep any remaining beads inside the apparatus.

FIG. 3 is an illustration showing the bottom part of the apparatus 300 according to an embodiment of the invention. In FIG. 3 the top work-surface 310 has two slits 315. A Velcro® fabric 320 is thread through the slits 315. In this manner, the apparatus may be used on any size finger. On the other hand, using the same construction but at a larger size, the apparatus may be used on the wrist, like a wristband.

FIG. 4 illustrates another embodiment of the invention, which may be structured in the form of a ring or wristband 400. The apparatus 400 comprises a top work-surface part 410 having a flat or curved top surface 414, and a curved underside 412 so as to stabilize the work-surface part 414 over a user's finger or arm. Velcro bands 420 are threaded through extensions 415 to enable fit to various size fingers or wrists. The top surface 414 is provided with a tacky layer, such as a spray-on tacky layer, or a double-sided tape, as in the previous embodiments. A cover 450 is structured to fit over the top work-surface part 410. The top 450 comprises a storage cavity 452 and a lid 454, so that beads or other small items may be stored in the storage cavity.

FIGS. 5A and 5B illustrate another embodiment. The embodiment of FIGS. 5A and 5B is cheap and simple to manufacture. As illustrated in FIG. 5A, a sheet metal is stamped to provide the flat cutout 502, comprising a work-surface part 510 and ring extensions 520. The cutout is then folded to provide a ring 500 comprising a work-surface 510, having top surface 514, sides 516, and ring extensions 520. A tacky layer, such as a spray-on or double-sided tape is then provided over the flat top surface 514.

FIG. 6 illustrates another embodiment, wherein the work-surface 610 of apparatus 600 is made in the form of an I-beam. This can be made by, e.g., extruding plastic. The I-bean shape provides a flat top surface 614 and a bottom cavity 612, which can be fit over the user's finger or arm—depending on the apparatus' size. Slots 615 are provided through the bottom part of body 610, to thread Velcro strips 620 or other attachment bands therethrough. A cover 650 is provided with an elongated storage compartment 652, having removable cap 654. The elongated storage compartment is particularly suitable for storing needles. The cover 650 is structured to snap onto extensions 617 to be secured in place. Alternately, this can be a magnet or clasp.

FIG. 7 illustrates another embodiment of the invention. In FIG. 7, top work-surface 710 is provided with a slightly curved top 714 and bottom cavity 712. Slots 715 are provided for threading an elastic or other attachment band 720. Tacky layer or tape is provided on the curved surface 714. A cover 750 is provided to snap onto extensions 717 to be secure to the top work-surface 710. The cover 750 is provided with a storage compartment 752 and a lid 754.

FIG. 8 illustrates another embodiment, which may be made by plastic molding to result in a top work-surface 810 having a top surface 814 for the application of the tacky layer or tape. The molding also provides ring sides or curved sections 820 which are flexible so as to fit various finger sizes.

FIG. 9 illustrate an embodiment of the invention which may be implemented as a ring or a wristband. In FIG. 9 the ring 900 may be made according to any of the embodiments described above, so as to comprise a top work-surface 910 having a top surface 914 with tacky layer or tape, and ring part 920. Additionally, a flexible neck 905 attached to the top work-surface 910 and supports a frame 980. The frame 980 has a magnifying glass 982, an illumination source 984, or both. In this embodiment, the illumination source is a white LED.

In a similar manner a wristband 900A is constructed to have a top work-surface 910A and a wristband part 920A. The flexible neck 905A supports a frame 980A, which has magnifying glass 982A, illumination source 984A, or both. A battery pack 970 is attached to the wristband and delivers energy to the illumination source via wire 972. While in this embodiment the wire 972 is shown for illustration purposes, it may be hidden inside the wristband 920A and the flexible neck 905A.

FIG. 10 illustrates an embodiment wherein the work surface 1010 is rotatable. Specifically, in this embodiment the work surface 1010 is rotatably attached to the ring or wristband attachment part 1020 via pivot 1030. In this manner, the user can position the work surface in any radial orientation that is convenient for the user.

FIG. 11 illustrates an embodiment wherein the work surface 1110 includes a cover 1120, which, when opened, can also function as a work surface. In this specific embodiment, the cover 1120 is made of two pieces hinged to the main work surface 1110. As illustrated by the arrows, the cover parts 120 can be closed over the work surface about hinges 1151. When the cover pieces 1120 are in the open position, beads 1144 can be placed on the main work surface 1110 and on the inside of the cover parts 1120. That is, adhesive is also placed on the inside of cover 1120, so that beads can be adhered to the inner side of the cover 1120.

FIG. 12 illustrates an embodiment wherein the working surface is provided with undulations or corrugation so as to increase the working surface. In FIG. 12 only the main working surface 1210 is provided with increased working surface, although the inner surface of the cover 1220 may also be provided with undulations or corrugations to increase its usefulness as a working surface when it is in the open position.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. Various aspects and/or components of the described embodiments may be used singly or in any combination in the plasma chamber arts. It is intended that the specification and examples be considered as exemplary only, with a true scope and spirit of the invention being indicated by the following claims.

1. An apparatus suitable for beading, comprising:
a ring part suitable for wearing on a user's finger or arm;
a top work-surface part affixed to the ring part;
a tacky film provided over the top work-surface.

2. The apparatus of claim 1, wherein the ring part comprises plastic material.

3. The apparatus of claim 1, wherein the ring part comprises elastic band.

4. The apparatus of claim 1, wherein the ring part comprises Velcro®.

5. The apparatus of claim 1, wherein the tacky firm comprises a two-sided tape.

6. The apparatus of claim 1, wherein the tacky firm comprises a plurality of tapes staked one on top of the other.

7. The apparatus of claim 1, further comprising a neck and a frame attached to the neck, the frame supporting at least one of a magnifying glass and an illumination source.

8. The apparatus of claim 7, wherein the illumination source is a white-light LED.

9. The apparatus of claim 1 further comprising a top cover mountable to the top work-surface.

10. The apparatus of claim 9, wherein the top cover further comprises a storage compartment.

11. The apparatus of claim 1, wherein the top work-surface comprises a flat top.

12. The apparatus of claim 1, wherein the top work-surface comprises a curved top.

13. The apparatus of claim 1, wherein the ring part comprises two curved sections.

14. The apparatus of claim 1, wherein the ring part and the top work-surface part comprise a stamped sheet metal.

15. The apparatus of claim 1, wherein the top work-surface part comprises an I-beam structure.

16. A method of manufacturing an apparatus for beading, comprising:
fabricating a ring part;
fabricating a work-surface affixed to the ring part;
providing a tacky layer over the work-surface.

17. The method of claim 16, wherein the steps of fabricating a ring part and fabricating a work-surface are performed simultaneously by stamping a sheet metal.

18. The method of claim 16, wherein the steps of fabricating a ring part and fabricating a work-surface are performed simultaneously by molding plastic.

19. The method of claim 16, wherein the steps of fabricating a ring part comprises providing a two part Velcro® band.

20. The method of claim 16, further comprising affixing a neck to the work-surface and affixing at least one of a magnifying glass and an illumination source to the neck.
